(19) United States
(12) Patent Application Publication
(10) Pub. No.: US 2009/0184592 A1
(43) Pub. Date: Jul. 23, 2009

(54) ROTATING ELECTRIC MACHINE

(76) Inventors: Shinya Sano, Toyota-shi (JP); Kazutaka Tatematsu, Nagoya-shi (JP); Tomoka Sonohara, Toyota-shi (JP); Atomi Arakawa, Anjo-shi (JP)

Correspondence Address: KENYON & KENYON LLP, 1500 K STREET N.W., SUITE 700, WASHINGTON, DC, 20005, US

(21) Appl. No.: 12/350,399

(22) Filed: Jan. 8, 2009

(30) Foreign Application Priority Data
Jan. 17, 2008 (JP) 2008-007783

(51) Int. Cl. H02K 9/02; H02K 7/08

(52) U.S. Cl. 310/59; 310/90

(57) ABSTRACT

A rotating electric machine is provided that includes a rotating portion including a rotating shaft, a housing enclosing at least a part of the rotating shaft, and a stator coil accommodated in the housing. A static coolant supply portion supplies coolant to the stator coil from the outside of the stator coil in a radial direction of the rotating shaft. A rotating coolant supply portion supplies coolant to the stator coil from the inside of the stator coil in the radial direction of the rotating shaft. A guide portion is provided in the housing and extends toward the inner surface of the stator coil in the radial direction of the rotating shaft. The guide portion has a through hole through which coolant flows.

### INCORPORATION BY REFERENCE

The disclosure of Japanese Patent Application No. 2008-7783 filed on Jan. 17, 2008 including the specification, drawings and abstract is incorporated herein by reference in its entirety.

### BACKGROUND OF THE INVENTION

1. Field of the Invention

The present invention relates to a rotating electric machine, in particular, to a rotating electric machine that is mounted on a vehicle, such as an automobile.

2. Description of the Related Art

In a rotating electric machine, such as a motor, it is important to cool the heat generated at a coil efficiently, and various cooling systems are available. For example, Journal of Technical Disclosure No. 2006-504798 describes a structure in which a guide member is provided under coil ends to conduct a cooling oil supplied from above the coil ends in a circumferential direction of the coil. Japanese Patent Application Publication No. 2005-73351 (JP-A-2005-73351) describes a cooling structure of a rotating electric machine that supplies a coolant from a rotating shaft to stator coil ends. Japanese Patent Application Publication No. 2004-215353 (JP-A-2004-215353) describes a rotating electric machine in which coolant is supplied from the rotating shaft or an upper portion of a case, and that has a structure in which a porous body abuts on the coil ends to hold coolant.

In the cooling structure described in Journal of Technical Disclosure 2006-504798, cooling oil is supplied only from above the coil ends. Thus, the cooling oil may not be sufficiently supplied to the coil ends. As a result, the coil ends may not be cooled sufficiently. In order to increase the amount of cooling oil supplied to the coil ends, cooling oil may be supplied from a rotor side to the coil ends as well. However, if the guide member described in Journal of Technical Disclosure 2006-504798 is provided, the flow of coolant may be blocked and the coolant may not be sufficiently supplied from the rotor side to the coil ends.

### SUMMARY OF THE INVENTION

The present invention provides a rotating electric machine that cools coil ends efficiently.

One aspect of the present invention provides a rotating electric machine that includes a rotating portion including a rotating shaft; a housing enclosing at least a part of the rotating shaft; a stator coil accommodated in the housing; a static coolant supply portion that supplies coolant to the stator coil from the outside of the stator coil in a radial direction of the rotating shaft; a rotating coolant supply portion that supplies coolant to the stator coil from the inside of the stator coil in the radial direction of the rotating shaft; and a guide portion that is provided in the housing and extends toward the inner surface of the stator coil in a radial direction of the rotating shaft, wherein the guide portion has a through hole through which coolant flows.

The rotating electric machine may further include a rotor core that is fixed to the rotating shaft, and an end plate that faces an axial end surface of the rotor core. A coolant passage may be formed between the end plate and the axial end surface of the rotor core, and coolant is supplied to the stator coil through the coolant passage.

A bearing may be provided on the housing and supports the rotating shaft to be rotatable with respect to the housing. The coolant may be supplied to the stator coil via the bearing.

The guide member may be provided above the rotating shaft. The guide member may include a curved portion that is curved inward in the radial direction of the rotating shaft such that a portion of the guide member is positioned lower, as the portion approaches the stator coil in the axial direction of the rotating shaft.

Further, at least a portion of the coolant supplied from the rotating coolant supply portion may reach the inner surface of the stator coil via the through hole formed in the guide member.

According to the aspect of the present invention, because the guide member includes the through hole, coolant passes through the through hole, and an increased amount of coolant may reach the stator coil. As a result, the stator coil is effectively cooled.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a cross-sectional view showing details of a rotating electric machine according to a first embodiment of the present invention;

FIG. 2 is an enlarged cross-sectional view of a portion of the rotating electric machine shown in FIG. 1;

FIG. 3 is a view of a guide member viewed from a stator side; and

FIG. 4 is an enlarged cross-sectional view of a portion of a rotating electric machine according to a second embodiment of the present invention.

### DETAILED DESCRIPTION OF EMBODIMENTS

Embodiments of the present invention will be described hereinafter with reference to drawings. In the drawings, the same or similar components are denoted by like reference numerals, and the explanation will not be repeated.

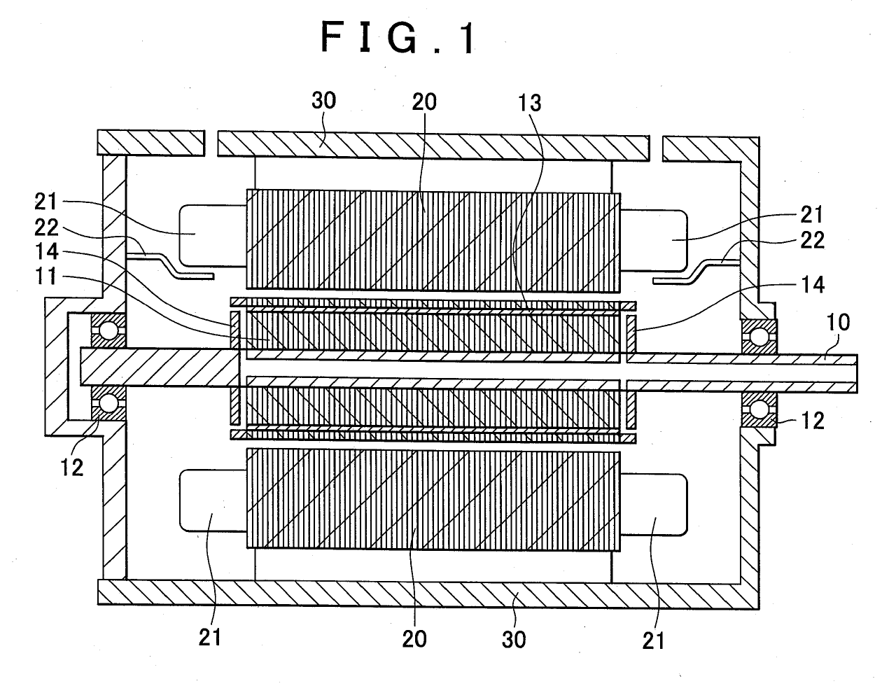

FIG. 1 is a cross-sectional view showing details of a rotating electric machine according to a first embodiment of the present invention. The rotating electric machine is mounted on a hybrid vehicle, and functions as a driving source that drives vehicle wheels or a generator that generates electricity from power of an engine. It may also be mounted on an electric car, and used as a driving source that drives vehicle wheels.

As shown in FIG. 1, the rotating electric machine includes a rotating shaft 10, which is rotatable, and a housing 30 that encloses a part of the rotating shaft 10. The housing 30 rotatably supports the rotating shaft 10 via two bearings 12. The rotating electric machine is disposed such that the rotating shaft 10 extends generally horizontally. The rotating electric machine further includes a rotor and an annular stator in the housing 30. The rotor is fixed on the rotating shaft 10 and rotates with the rotating shaft 10. The stator is disposed around the outer circumference of the rotor.

The rotor includes a rotor core 11 fixed on the rotating shaft 10. The rotor also includes a permanent magnet 13 that is embedded in a magnet insertion hole formed in the rotor core 11 so as to penetrate multiple magnetic steel sheets of the rotor core 11. In other words, the rotating electric machine is an interior permanent magnet motor (IPM motor). The rotor includes end plates 14 respectively facing axial end surfaces of the rotor core 11.

The permanent magnet 13 is adhered and fixed to the rotor core 11 with resin filled in the magnet insertion hole. The rotor core 11 has a cylindrical shape extending along the rotation axis of the rotating shaft 10. The rotor core 11 is formed of multiple magnetic steel sheets stacked on each other in the axial direction of the rotating shaft 10.

The two end plates 14 provided at both axial end surfaces of the rotor core 11 hold the stack of magnetic steel sheets therebetween in the axial direction. When end portions of the magnetic steel sheets facing the permanent magnet 13 are magnetized, magnetic energy creates a force to separate the magnetic steel sheets from each other. However, because the end plates 14 hold the stack of magnetic steel sheets therebetween, the separation of the magnetic steel sheets is prevented. The end plates 14 are fixed to the rotating shaft 10 by an appropriate method, such as screw cramp, caulking or press fitting. The end plates 14 rotate along with the rotation of the rotating shaft 10.

The stator includes an annular stator core 20 that surrounds the circumference of the rotor core 11, and a stator coil wound around the stator core 20. The stator core 20 is disposed to face the outer circumferential surface of the rotor core 11, and a narrow gap is formed therebetween. The stator core 20 is accommodated in the housing 30 and is formed of multiple magnetic steel sheets stacked on each other in the axial direction of the rotating shaft 10. Note that each of the rotor core 11 and the stator core 20 is not limited to the magnetic steel sheets, but may be an integrated component made of a powder magnetic core, for example.

The stator core 20 has slits that pass through the stator core 20 in the axial direction of the rotating shaft 10. The stator coil is fit in the slits. The stator coil is accommodated in the housing 30 and is fixed to the stator core 20 via insulating members disposed in the slits of the stator core 20. End portions of the stator coil wound around the stator core 20 form coil ends 21 on both sides of the stator core 20.

A guide member 22 is disposed in the housing 30. The guide member 22 is located above the rotating shaft 10 that extends generally horizontally. The guide member 22 generally extends in the axial direction of the rotating shaft 10. The guide member 22 extends toward the inner surface 21b of the stator coil in a radial direction of the rotating shaft (i.e., the surface on the side of the rotating shaft 10).

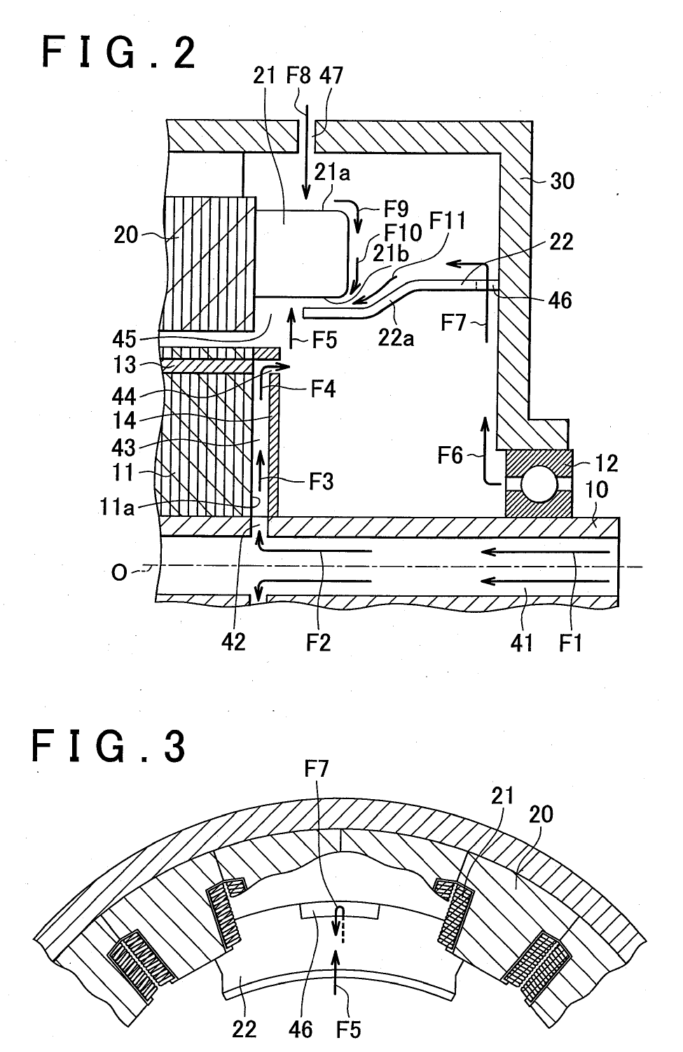

FIG. 2 is an enlarged cross-sectional view of a portion of the rotating electric machine shown in FIG. 1. As shown in FIG. 2, the rotating shaft 10 is rotatably supported by the bearings 12. The bearings 12 are attached to the housing 30, and support the rotating shaft 10 so as to be rotatable with respect to the housing 30. In FIG. 1 and FIG. 2, the bearing 12 is shown as a ball bearing with balls as rolling elements. However, roller bearings with rollers as rolling elements, or sliding bearings may be used, instead. Lubricant is supplied to the bearing 12 to lubricate the space formed by the rolling elements, an inner race, and an outer race of the bearing 12.

The rotating shaft 10 is hollow. A coolant passage 41 is formed in the rotating shaft 10 that extends in the axial direction thereof and includes the rotation center axis O of the rotating shaft 10. A coolant passage 42 is also formed in the rotating shaft 10 that extends in the radial direction of the rotating shaft 10. The rotating shaft 10 is disposed such that the rotation center axis O extends in the horizontal direction.

A coolant passage 43 is formed between the end plate 14 and an axial end surface 11a of the rotor core 11. The coolant passage 43 is arranged to communicate with the coolant passage 43. The end plate 14 has an opening 44 that communicates between the coolant passage 43 and the interior space of the housing 30.

The guide member 22 is fixed to the housing 30. The guide member 22 generally extends in the axial direction of the rotating shaft 10. The guide member 22 includes a curved portion 22a that is curved from the upper side to the lower side of the stator coil. The curved portion 22a of the guide portion 22 is curved in the radial direction of the rotating shaft 10. The guide member 22 is curved inward in the radial direction of the rotating shaft 10. The guide member 22 is curved to approach the inner surface 21b of the stator coil in the radial direction of the rotating shaft 10, as approaching the coil end 21 in the direction of the rotation center axis O (i.e., in the, axial direction of the rotating shaft 10). In other words, a portion of the guide member is positioned lower, as the portion approaches the stator coil in the axial direction of the rotating shaft.

The guide member 22 does not contact the stator core 20. Thus, a gap 45 is formed between the guide member 22 and the stator core 20. The guide member 22 has a through hole 46 that penetrates the guide member 22 in the thickness direction of the guide member 22.

The housing 30 has a coolant supply hole 47 that conducts coolant from outside to the inner space of the housing 30.

The rotating shaft 10, the rotor core 11, an inner race of the bearing 12, the permanent magnet 13 and the end plate 14 are rotatable about the rotation center axis O, and may be included in the rotating portion. On the other hand, an outer race of the bearing portion 12, the stator core 20, the coil end 21, the guide member 22 and the housing 30 may be included in the static portion that supports the rotating portion.

A cooling structure of the rotating electric machine according to the first embodiment will be described hereinafter with reference to FIG. 2. When the stator coil provided on the circumference of the stator core 20 is electrified, the stator coil 20 generates magnetic force that rotates the rotor core 11. At this time, Joule heat is generated by a current flowing in the stator coil, and thus, the stator core 20, the stator coil and the coil ends 21 produce heat. In order to operate the rotating electric machine stably, it is important to remove the heat. Therefore, in the rotating electric machine, coolant is supplied to the coil ends 21 of the stator coil to remove the heat.

Cooling oil that cools the coil ends 21 is supplied from the housing 30. As shown by arrow F8, cooling oil is supplied to the coil ends 21 from the outside of the stator coil in a radial direction of the rotating shaft 10 (i.e., from the upper side of the rotating electric machine) through the coolant supply hole 47 formed in the housing 30 above the stator coil. After contacting the surface 21a of the coil end 21, as shown by arrow F9, the cooling oil flows inward in the radial direction of the rotating shaft 10 (i.e., toward the lower side of the rotating electric machine) due to the force of gravity.

The coolant supply hole 47 is included in a static coolant supply portion formed in the housing 30 that supplies coolant for cooling the stator coil from the outside of the stator coil in the radial direction of the rotating shaft 10 to the outer surface 21a of the coil end 21 of the stator coil in the radial direction of the rotating shaft 10.

Cooling oil for cooling the coil end 21 is also supplied from the rotor side. The cooling oil supplied from outside of the rotating electric machine into the coolant passage 41 formed in the hollow rotating shaft 10 flows along the rotation center axis O in the cooling passage 41, as shown by the arrow F1. The cooling oil flows on the wall surface of the coolant passage 41 due to the centrifugal force generated by the rotation of the rotating shaft 10. Then, due to the centrifugal force, a part of the cooling oil that reaches the position of the coolant passage 42 flows into the coolant passage 42, and flows outward in the radial direction of the rotating shaft 10 through the coolant passage 42.

Then, the cooling oil flows into the coolant passage 43, and flows through the coolant passage 43 as shown by arrow F3, thereby cooling the axial end surface 11a of the rotor core 11. The cooling oil then reaches the opening 44 as shown by arrow F4, and flows into the interior space of the housing 30 through the opening 44. Because the centrifugal force generated by the rotation of the rotor is applied to the cooling oil, the cooling oil is sprayed and splashed toward the outer circumference side of the rotor (i.e., radially outward) from the opening 44. Then, the cooling oil reaches, as shown by arrow F5, the inner surface 21b of the coil end 21 of the stator coil in the radial direction of the rotating portion, and cools the coil end 21. Because the gap 45 is formed between the guide member 22 and the stator core 20, the cooling oil sprayed from the opening 44 reaches the surface 21b of the coil end 21 through the gap 45.

Lubrication oil supplied to lubricate the bearings 12 may function as coolant supplied from the rotor side to cool the coil end 21. The lubrication oil is supplied from outside of the rotating electric machine into the space formed by the rolling elements, the inner race and the outer race of the bearing 12, and lubricates the bearing 12. A centrifugal force generated by the rotating action of the inner race of the bearing 12 is applied to the lubrication oil that lubricates the bearing 12. Therefore, once the lubrication oil flows into the interior space of the housing 30, the lubrication oil then flows outward in the radial direction of the rotating electric machine, as shown by arrow F7. After the lubrication oil reaches the guide member 22, as shown by arrow F7, the lubrication oil flows into the interior space of the housing 30 on the outer side of the guide member 22 in the radial direction of the rotating shaft 10 (i.e. above the guide member 22) through the through hole 46 formed in the guide member 22. The lubrication oil is supplied to the interior space of the housing 30 from the lower side of the guide member 22, and flows into the upper side of the guide member 22. That is, the lubrication oil passes through the through hole 46 from the lower side to the upper side of the guide member 22.

FIG. 3 is a view of the guide member viewed from the stator side. As shown in FIG. 3, the stator coil is wound around the stator core 20, and stator cores 20 are arranged in an annular shape to form the stator. The guide member 22 is a plate curved along the annular circumference of the stator. The through hole 46 is formed in the guide member 22. Therefore, the coolant flows outward, as shown by arrow F7, from inside to outside in the radial direction of the rotating shaft 10 through the through hole 46. Meanwhile, as shown by arrow F5, coolant flows radially outward, i.e., from the inside to outside in the radial direction of the rotating shaft 10, through the gap 45 (see FIG. 2) near the stator where the guide member 22 is not formed.

Thus, the coolant passage 41 to 43, the opening 44 and the bearing 12 is included in a rotating coolant supply portion that supplies coolant for cooling the inner surface 21b of the coil end 21 of the stator coil in a radial direction the rotating shaft from the inside of the stator coil.

As shown by arrows F10 and F11, respectively, the cooling oil supplied from the coolant supply hole 47 in the housing 30 and the lubrication oil supplied via the bearing 12 flow on the guide member 22 along the direction of the rotation center axis O toward the stator core 20. Then, the cooling oil and the lubrication oil flow on the inner surface 21b, and cool the stator coil. Thus, the guide member 22 conducts the coolant to the surface 21b of the coil end 21 on the lower side of the coil end 21 of the stator coil.

Because the through hole 46 is formed in the guide member 22, the lubrication oil supplied to lubricate the bearing 12 flows from the bearing 12 to the interior space of the housing 30, and then reaches the inner surface 21b of the coil end 21 through the through hole 46. Thus, the lubrication oil is supplied on the inner surface 21b of the coil end 21 as a coolant that cools the stator coil.

The guide member 22 has a curved portion 22a that is curved from the upper side to the lower side of the stator coil. The guide member 22 extends from the upper side to the lower side of the rotating electric machine, as approaching the coil end 21. As shown in FIG. 2, the end of the guide member 22 close to the coil end 21 is positioned relatively low compared to the end of the guide member 22 fixed to the housing 30. Because the guide member 22 is formed in this shape, the coolant flows from the upper side to the lower side due to the force of gravity. Thus, as shown by arrows F10 and F11, the coolant readily flows toward the coil end 21 along the guide member 22. Accordingly, the coolant is securely supplied on the inner surface 21b of the coil end 21, and the stator coil is cooled efficiently.

After cooling the coil end 21, the coolant flows toward the oil pan (not shown) disposed at the lower portion in the housing 30, and is collected or stored in the oil pan.

As described above, in the rotating electric machine according to the first embodiment, the through hole 46 is formed in the guide member 22 that conducts the coolant toward the inner surface 21b of the coil end 21 of the stator coil. Therefore, the coolant flowing into the interior space of the housing 30 through the bearing 12 as shown by arrow F6 flows toward the coil end 21 of the stator coil through the through hole 46 in the guide member 22 as shown by arrow F7. Accordingly, in addition to the static coolant supply portion of the rotating electric machine, the rotating coolant supply portion supplies coolant to the stator coil. As a result, the stator coil is cooled efficiently.

Further, as shown in FIG. 1, the guide member 22 is only located above the rotating shaft 10 of the rotating electric machine. On the lower side of the rotating shaft 10 of the rotating electric machine, the coolant that is supplied from the rotating portion and reaches to the coil end 21 flows down from the upper side to the lower side of the coil end 21 on the surface of coil end 21 due to the force of gravity. Therefore, on the lower side of the rotating shaft 10 of the rotating electric machine, even if the guide member 22 is not provided, coolant is supplied to both the upper side and the lower side of the coil end 21.

On the other hand, on the upper side of the rotating shaft 10, because the guide member 22 is provided above the rotating shaft 10 of the rotating electric machine, the coolant supplied from the rotating portion reaches the lower side of the stator coil securely. In other words, if the guide member 22 is provided above the rotating shaft 10 of the rotating electric machine, the coolant is securely supplied to the lower side of the stator coil, and so the stator coil is cooled efficiently. Further, because the guide member 22 is only provided above the rotating shaft 10 of the rotating electric machine, the manufacturing cost of the rotating electric machine is reduced, compared to the case in which the guide member 22 is formed over the entire inner circumference of the housing 30 of the rotating electric machine.

In the first embodiment, coolant is supplied to the coil end 21 of the stator coil from all of the bearing 12, and the coolant passages 41-43 and opening 44. In the first embodiment, coolant is conducted to the stator coil via both the bearing 12 and the coolant passages 41-43. However, the rotating electric machine of the present invention is not limited thereto. In the rotating electric machine, coolant may be supplied to the stator coil via at least one of the bearing 12 and the coolant passages 41-43.

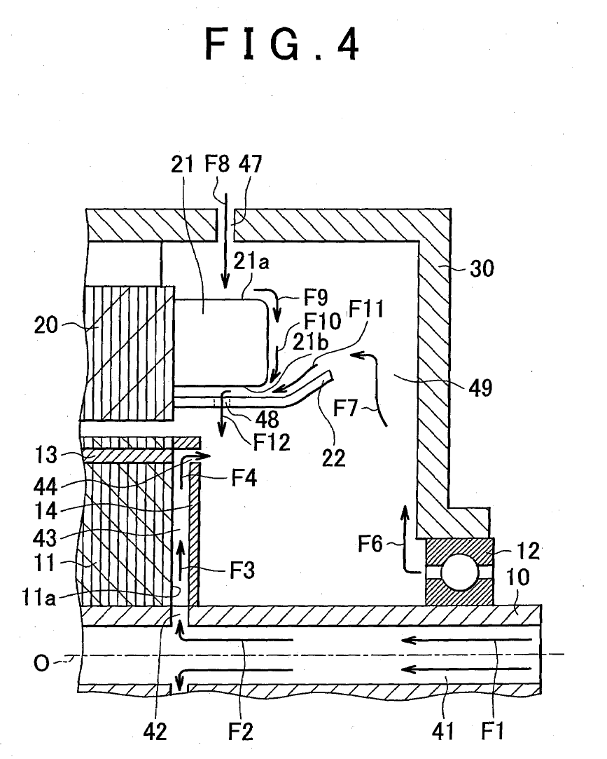

FIG. 4 is an enlarged cross sectional view of a portion of a rotating electric machine according to a second embodiment of the present invention. The rotating electric machine of the second embodiment is different from that of the first embodiment in the shape and position of the guide member 22, as shown in FIG. 4. More specifically, as shown in FIG. 4, the guide member 22 is fixed to an axial end surface of the stator core 20. A gap 49 is formed between the end of the guide member 22 apart from the stator core 20 and the housing 30. The guide member 22 is a plate and includes a through hole 48 that penetrates the guide member 22 in the thickness direction thereof.

According to the rotating electric machine of the second embodiment, as shown by arrow F8, coolant is supplied on the outer surface 21a of the coil end 21 in the radial direction of the rotating shaft 10 through the coolant supply hole 47. After the coolant hits the surface 21a of the coil end 21, the coolant flows toward the lower side of the rotating electric machine as shown by arrow F9, due to the force of gravity. Further, lubrication oil flowing into the interior space of the housing 30 from the bearing 12 flows toward the outer circumference of the rotating electric machine as shown by arrow F6, and reaches the guide member 22. Then, the lubrication oil flows toward the upper side of the guide member 22 via the gap 49, i.e., flows into the interior space of the housing 30 on the outer circumference side of the guide member 22.

The cooling oil supplied from the coolant supply hole 47 in the housing 30 and the lubrication oil supplied from the bearing 12 respectively flow as shown by arrows F10 and F11 so as to flow on the guide member 22 in the axial direction of the rotation center axis O, and then flows on the inner surface 21b of the coil end 21 of the stator coil to cool the stator coil. Thereafter, the coolant passes through the through hole 48 formed in the guide member 22 as shown by arrow F12, and is collected in an oil pan (not shown) provided at the lower portion in the housing 30.

According to the second embodiment, the guide member 22 blocks the flow of the cooling oil toward the coil end 21 that has flown through the coolant passages 41-43 and cooled the axial end surface 11a of the rotor core 11. Thus, the amount of cooling oil flowing toward the coil end 21 may be reduced. However, the lubrication oil flowing into the interior space of the housing 30 via the bearing 12 further flows to the inner surface 21b of the oil end 21 of the stator coil, and cools the surface 21b of the coil end 21. Accordingly, coolant is supplied from the rotating portion side of the rotating electric machine, and so the stator coil is cooled efficiently.

The attachment position, size and shape of the guide member 22 may be adjusted based on the cooling capacities of the static coolant supply portion and the rotating coolant supply portion. Further, the size of through holes formed in the guide member and the width between the guide member and the static portion of the rotating electric machine, such as the gap 45 and through hole 46 in the first embodiment and the gap 49 and the through hole 48 in the second embodiment, may be adjusted based on the cooling capacities of the static coolant supply portion and the rotating coolant supply portion.

While some embodiments of the invention have been illustrated above, it is to be understood that the invention is not limited to details of the illustrated embodiments, but may be embodied with various changes, modifications or improvements, which may occur to those skilled in the art, without departing from the spirit and scope of the invention.

What is claimed is:

1. A rotating electric machine comprising:
a rotating portion including a rotating shaft;
a housing enclosing at least a part of the rotating shaft;
a stator coil accommodated in the housing;
a static coolant supply portion that supplies coolant to the stator coil from the outside of the stator coil in a radial direction of the rotating shaft;
a rotating coolant supply portion that supplies coolant to the stator coil from the inside of the stator coil in the radial direction of the rotating shaft; and
a guide portion that is provided in the housing and extends toward an inner surface of the stator coil in the radial direction of the rotating shaft, wherein the guide portion has a through hole through which coolant flows.

2. The rotating electric machine according to claim 1, further comprising:
a rotor core that is fixed to the rotating shaft; and
an end plate that faces an axial end surface of the rotor core,
wherein a coolant passage is formed between the end plate and the axial end surface of the rotor core, and coolant is supplied to the stator coil through the coolant passage.

3. The rotating electric machine according to claim 1, further comprising a bearing that is provided on the housing and supports the rotating shaft to be rotatable with respect to the housing,
wherein coolant is supplied to the stator coil via the bearing.

4. The rotating electric machine according to claim 1, wherein the guide member is provided above the rotating shaft.

5. The rotating electric machine according to claim 4, wherein the guide member includes a curved portion that is curved inward in the radial direction of the rotating shaft such that a portion of the guide member is positioned lower, as the portion approaches the stator coil in the axial direction of the rotating shaft.

6. The rotating electric machine according to claim 1, wherein at least a portion of the coolant supplied from the rotating coolant supply portion reaches the inner surface of the stator coil via the through hole formed in the guide member.

7. The rotating electric machine according to claim 1, wherein the static coolant supply portion includes a coolant supply hole formed in the housing at the position above the stator coil.

8. The rotating electric machine according to claim 2, wherein the rotating coolant supply portion includes an in-shaft coolant passage provided in the rotating shaft, and the in-shaft coolant passage communicates with the coolant passage between the end plate and the axial end surface of the rotor core.

9. The rotating electric machine according to claim 1, wherein the guide member is attached on an inner surface of the housing.

10. The rotating electric machine according to claim 1, wherein the guide member is attached on an axial end surface of a stator core of the stator coil.

11. The rotating electric machine according to claim 9, wherein a gap is formed between the guide member and a stator core of the stator coil, and at least a portion of the coolant supplied from the rotating coolant supply portion reaches the inner surface of the stator core via the gap.

12. The rotating electric machine according to claim 10, wherein a gap is formed between the guide member and the housing, and at least a portion of the coolant supplied from the rotating coolant supply portion reaches the inner surface of the stator coil via the gap.

13. The rotating electric machine according to claim 3, wherein the coolant supplied via the bearing is lubricant that lubricates the bearing.
